(19) United States
(12) Patent Application Publication
(10) Pub. No.: US 2010/0223755 A1
(43) Pub. Date: Sep. 9, 2010

(54) HINGE SLEEVE FOR FOLDABLE ELECTRONIC DEVICES

(75) Inventors: YAN-LONG LIU, Shenzhen City (CN); HSIAO-HUA TU, Shindian (TW); JUN WANG, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/550,964

(22) Filed: Aug. 31, 2009

(30) Foreign Application Priority Data
Mar. 7, 2009 (CN) 200910300746.3

(51) Int. Cl. E05D 11/00

(52) U.S. Cl. 16/250

(57) ABSTRACT

A hinge structure of a foldable electronic device includes a body section and a cover section. The hinge structure includes a hinge sleeve longitudinally defining a slot. An outer surface of the hinge sleeve forms a coarse surface. The hinge sleeve rotatably connects the cover section to the body section. The coarse surface allows the cover section to maintain any of a variety of selectable positions relative to the body section.

### BACKGROUND

1. Technical Field

The present disclosure relates to hinge structures, and particularly to a hinge sleeve for foldable electronic devices, such as mobile phones and portable computers.

2. Description of Related Art

Presently, perhaps the most popular portable electronic device in the market is the foldable mobile phone, which generally includes a cover section and a body section. The cover section and the body section are rotatably interconnected through a hinge assembly.

One kind of hinge assembly employs a cam and a follower, which makes the cover section fold outward from the body section and then maintain in an open position. The hinge assembly typically includes a cam having a concave portion, a follower having a convex portion, a shaft having a fixing end, and a spring. The cam and the follower are placed around the shaft. The spring resists the follower to make the concave portion tightly contact the convex portion. The cam, the follower, the shaft and the spring are received in a housing. The cover section rotates about the body section of the mobile phone by overcoming the force of the spring, thus making the concave portion rotate about the convex portion.

However, the foldable electronic device can only be opened to preset angles, because the cam can only stably engages with the coplanar end faces of follower at a few preset positions. In addition, the concave portion of the cam is designed with relatively sharp edges and corners, which are prone to being worn by repeated use. When this happens, the connection between the body section and the cover section is liable to deteriorate.

Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the present hinge sleeve. Moreover, in the drawings, like reference numerals designate corresponding parts throughout the several views, in which:

FIG. 1 is an exploded, isometric view of an exemplary foldable electronic device;

FIG. 2 is an assembled, isometric view of the exemplary foldable electronic device shown in FIG. 1.

### DETAILED DESCRIPTION

The present hinge sleeve is suitable for a foldable electronic device such as a manually opening mobile phone.

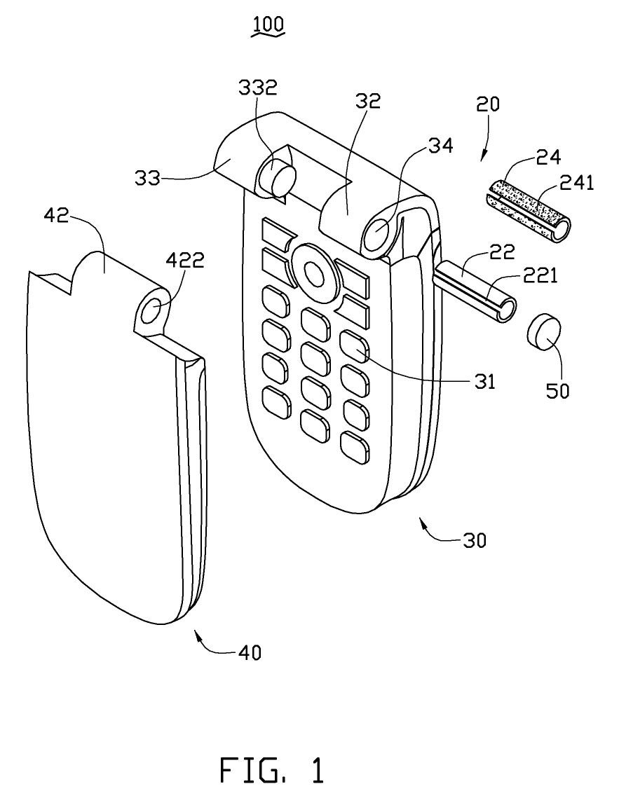

Referring to FIG. 1, an exemplary foldable electronic device 100 includes a hinge sleeve 20, a body section 30, a cover section 40 and a filler block 50. The hinge sleeve 20 is pivotably connected the body section 30 to the cover section 40.

The foldable electronic device 100 typically includes communications circuitry within the body section 30 and the cover section 40 to allow users to communicate with remote parties via a wireless communications network. Generally, such circuitry includes one or more microprocessors, memory, and long-range and/or short-range transceivers that operate according to any known standard. Suitable standards include, but are not limited to, the Global System for Mobile Communications (GSM), TIA/EIA-136, CDMAONE, CDMA2000, UMTS, Wideband CDMA, and BLUETOOTH.

The body section 30 includes a plurality of keys 31 for operating the foldable electronic device 100. The body section 30 integrally forms a knuckle 32 and a post 33 at one end thereof. The knuckle 32 faces with the post 33, and defines a through hole 34 longitudinally through the knuckle 32. A column 332 longitudinally extends from one end of the post 33 towards the knuckle 32.

The cover section 40 forms a barrel portion 42 at one end thereof. The barrel portion 42 mates between the knuckle 32 and the post 33 of the body section 30. The barrel portion 42 is substantially cylindrical, and defines a central hole 422 longitudinally through the barrel portion 42.

The hinge sleeve 20 is substantially cylindrical, and includes a sleeve body 22 and a covering layer 24. The sleeve body 22 is made of elastic metal. The sleeve body 22 defines a slot 221 longitudinally extending therethrough at one side of the sleeve body 22. The slot 221 may provide a deformable space when the sleeve body 22 is compressed to deform. The covering layer 24 is made of rubber, and is for completely overlying on the sleeve body 22. An outer surface of the covering layer 24 forms a plurality of even and uneven projections 241 for increasing coarseness of the surface. When the covering layer 24 is overlaid on the sleeve body 22, a diameter of the hinge sleeve 20 is larger than the diameter of the through hole 34 and the central hole 422. When the hinge sleeve 20 is inserted into the through hole 34, the hinge sleeve 20 is compressed to deform so as to allow the hinge sleeve 20 to be received in the through hole 34 and the central hole 422. Under the elastic role of the sleeve body 22, the projections 241 tightly resist an inner wall of the central hole 422 of the through hole 34.

The filler block 50 is substantially cylindrical, and engages in the through hole 34 to cover one end of the through hole 34 for preventing dust from entering.

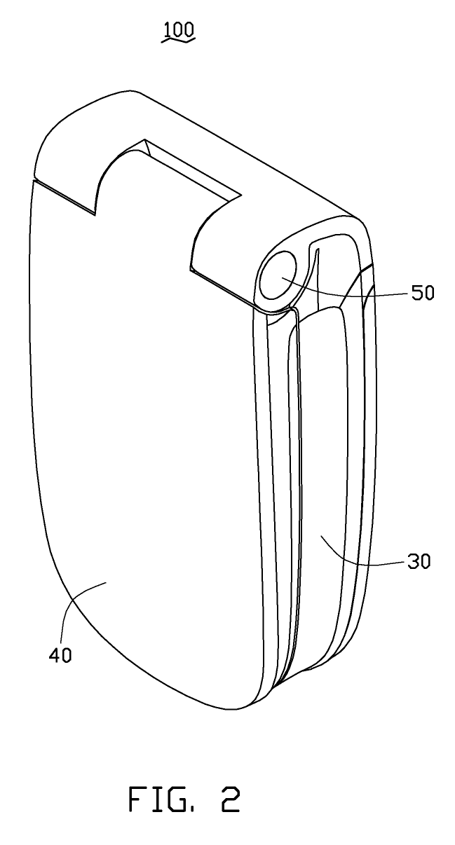

Referring to FIG. 2, when the hinge sleeve 20 is assembled to the foldable electronic device 100, the covering layer 24 is firstly tightly placed around the sleeve body 22. Then, the cover section 40 is positioned over the body section 42. The barrel portion 42 is positioned between the knuckle 32 and the post 33, and the column 332 is rotatably received in the central hole 422. The hinge sleeve 20 is then compressed by an external force to deform to a suitable size/diameter corresponding to that of the through hole 34 and the central hole 422. Then the deformed hinge sleeve 20 is inserted into the through hole 34 and the central hole 422. Finally, the filler block 50 is engaged into the open end of the through hole 34. Thus, the hinge sleeve 20 is completely assembled in the foldable electronic device 100. Since the hinge sleeve 20 has an elastic characteristic, the projections 241 not only tightly resist an inner wall of the central hole 422 and the through hole 34, but also allow the cover section 40 to rotatably connect the body section 30.

When the user wants to open the cover section 40 of the foldable electronic device 100, the cover section 40 is pushed to rotate relative to the body section 30. Since the covering layer 24 of the hinge sleeve 20 is made of rubber, and has a plurality of projections 241, a large friction is provided between the hinge sleeve 20 and the cover section 40. Thus, the hinge sleeve 20 can be maintained in a steady state in any of a variety of selectable positions. Accordingly, the cover section 40 becomes open relative to the body section 30 of the foldable electronic device 100.

Understandably, the projections 241 of the covering layer 24 may be a natural property of the rubber material. Alternatively, the projections 241 may be directly formed on the sleeve body 22 by manufacturing for increasing the coarseness.

It is believed that the present embodiments and their advantages will be understood from the foregoing description, and it will be apparent that different changes may be made thereto without departing from the spirit and scope of the invention or sacrificing all of its material advantages, the examples hereinbefore described merely being preferred or exemplary embodiments of the invention.

What is claimed is:

1. A hinge structure of a foldable electronic device comprising a body section and a cover section, the hinge structure comprising:
a hinge sleeve longitudinally defining a slot, an outer surface of the hinge sleeve having a coarse surface, the hinge sleeve rotatably connecting the cover section to the body section, the coarse surface allowing the cover section to maintain any of a variety of selectable positions relative to the body section.

2. The hinge structure as claimed in claim 1, wherein the hinge sleeve includes a sleeve body and a covering layer overlying the sleeve body, and the sleeve body is made of metal, and the covering layer is made of rubber.

3. The hinge structure as claimed in claim 2, wherein the covering layer includes a plurality of projections forming the coarse surface.

4. The hinge structure as claimed in claim 1, further comprising a filler block, wherein the body section includes a knuckle defining a through hole, and the filler block cover one open end of the through hole.

5. A foldable electronic device comprising:
a body section forming a knuckle and a post,
a cover section forming a barrel portion; the barrel portion being positioned between the knuckle and the post; and
a hinge sleeve rotatably connected the cover section to the body section, the hinge sleeve longitudinally defining a slot, an outer surface of the hinge sleeve forming a coarse surface, the hinge sleeve rotatably connecting the cover section to the body section, the coarse surface allowing the cover section to maintain any of a variety of selectable positions relative to the body section.

6. The foldable electronic device as claimed in claim 5, wherein the knuckle faces with the post, and the knuckle defines a through hole longitudinally through the knuckle.

7. The foldable electronic device as claimed in claim 6, further comprising a filler block, wherein the cover section includes a knuckle, the knuckle defines a through hole, and the filler block cover one open end of the through hole.

8. The foldable electronic device as claimed in claim 5, wherein a column longitudinally extends from one end of the post.

9. The foldable electronic device as claimed in claim 5, wherein the hinge sleeve includes a sleeve body and a covering layer overlying the sleeve body, and the sleeve body is made of metal, and the covering layer is made of rubber.

10. The foldable electronic device as claimed in claim 6, wherein the covering layer includes a plurality of projections to form the coarse surface.

11. A method of maintaining a foldable device in one of many positions, comprising:
providing a body portion having a through hole;
providing a cover portion having a central hole;
placing a radially compressible element in the central and through holes to create a friction force between the body portion and the cover portion that can maintain the body portion and cover portion in one of many different positions.
